(19) United States
(12) Patent Application Publication
(10) Pub. No.: US 2024/0240668 A1
(43) Pub. Date: Jul. 18, 2024

(54) SQUEEZE FILM DAMPER BEARING, BEARING DEVICE AND ROTATING MACHINE

(71) Applicant: MITSUBISHI HEAVY INDUSTRIES COMPRESSOR CORPORATION, Tokyo (JP)

(72) Inventor: Nobuhiro Nagata, Tokyo (JP)

(73) Assignee: MITSUBISHI HEAVY INDUSTRIES COMPRESSOR CORPORATION, Tokyo (JP)

(21) Appl. No.: 18/412,879

(22) Filed: Jan. 15, 2024

(30) Foreign Application Priority Data
Jan. 18, 2023 (JP) 2023-005786

(51) Int. Cl. F16C 27/04

(52) U.S. Cl. CPC F16C 27/045; F16C 2360/00

(57) ABSTRACT

A squeeze film damper bearing includes a squeeze film damper including an internal support ring configured to support a bearing part, which is allowed to support the rotor extending in an axis, via an inner peripheral surface of the internal support ring in a radial direction of the axis, and an external support ring installed outside the internal support ring in the radial direction so that an annular damper clearance which is filled with a viscous fluid is formed between the external support ring and the internal support ring, and a movement support part configured to support the squeeze film damper via the external support ring and to allow the external support ring to move relative to the internal support ring in a cross-sectional view perpendicular to the axis.

### BACKGROUND OF THE INVENTION

### Field of the Invention

The present disclosure relates to a squeeze film damper bearing, a bearing device, and a rotating machine.

Priority is claimed on Japanese Patent Application No. 2023-5786, filed Jan. 18, 2023, the content of which is incorporated herein by reference.

### Description of Related Art

In recent years, the axial length of rotors in rotating machines such as compressors has tended to increase. Although an increase in the axial length of the rotor is expected to improve performance, there is a risk that vibration of the rotor will increase and stability will decrease. As a countermeasure to this problem, a squeeze film damper bearing having a squeeze film damper which is a type of radial bearing has been proposed. In the squeeze film damper bearing, better vibration damping is achieved compared to ordinary bearings by introducing a viscous fluid into a damper clearance between an internal support ring that supports a bearing part and an external support ring disposed over the outer circumference of the internal support ring, forming a fluid film and imparting a so-called squeeze effect. As the width of the damper clearance becomes narrower, that is, as the film pressure of the fluid film decreases, the damping effect is enhanced. As such a squeeze film damper bearing, one described in Japanese Unexamined Patent Application, First Publication No. H7-119743 is known.

### SUMMARY OF THE INVENTION

However, in the squeeze film damper bearing described in Japanese Unexamined Patent Application, First Publication No. H7-119743, there is a possibility that the internal support ring and the external support ring will come into contact with each other due to static deflection caused by a rotor's own weight or a static load during operation. Therefore, it has been necessary to design the damper clearance between the internal support ring and the external support ring to be large to some extent in consideration of the possibility of contact between the internal support ring and the external support ring. Thus, damping performance due to the fluid film within the damper clearance has been limited.

The present disclosure has been made to solve the above problems, and an object thereof is to provide a squeeze film damper bearing, a bearing device, and a rotating machine that can improve damping performance.

In order to solve the above problems, the squeeze film damper bearing according to the present disclosure includes a squeeze film damper including an internal support ring configured to support a bearing part, which is allowed to support the rotor extending in an axis, via an inner peripheral surface of the internal support ring in a radial direction of the axis, and an external support ring installed outside the internal support ring in the radial direction so that an annular damper clearance which is filled with a viscous fluid is formed between the external support ring and the internal support ring, and a movement support part configured to support the squeeze film damper via the external support ring and to allow the external support ring to move relative to the internal support ring in a cross-sectional view perpendicular to the axis.

A bearing device according to the present disclosure includes the squeeze film damper bearing and the bearing part.

A rotating machine according to the present disclosure includes the bearing device and the rotor.

According to the squeeze film damper bearing, the bearing device, and the rotating machine of the present disclosure, damping performance can be improved.

### BRIEF DESCRIPTION OF THE DRAWINGS

FIG. 1 is a diagram showing a configuration of a rotating machine according to a first embodiment of the present disclosure.

FIG. 2 is a diagram of a squeeze damper bearing according to the first embodiment of the present disclosure when seen in an axial direction.

FIG. 3 is a diagram of a squeeze damper bearing according to a second embodiment of the present disclosure when seen in an axial direction.

FIG. 4 is a diagram of a squeeze damper bearing according to a modified example of the second embodiment of the present disclosure when seen from an axial direction.

FIG. 5 is a diagram showing a configuration of a rotating machine according to a third embodiment of the present disclosure.

FIG. 6 is a diagram of a squeeze damper bearing according to the third embodiment of the present disclosure when seen in an axial direction.

FIG. 7 is an enlarged view of a second sensor according to the third embodiment of the present disclosure.

FIG. 8 is a functional block diagram showing a functional configuration of a control part according to the third embodiment of the present disclosure.

FIG. 9 is a flowchart showing a procedure of an adjustment method according to a third embodiment of the present disclosure.

FIG. 10 is a hardware configuration diagram according to the third embodiment of the present disclosure.

### DETAILED DESCRIPTION OF THE INVENTION

### First Embodiment

### (Configuration of Rotating Machine)

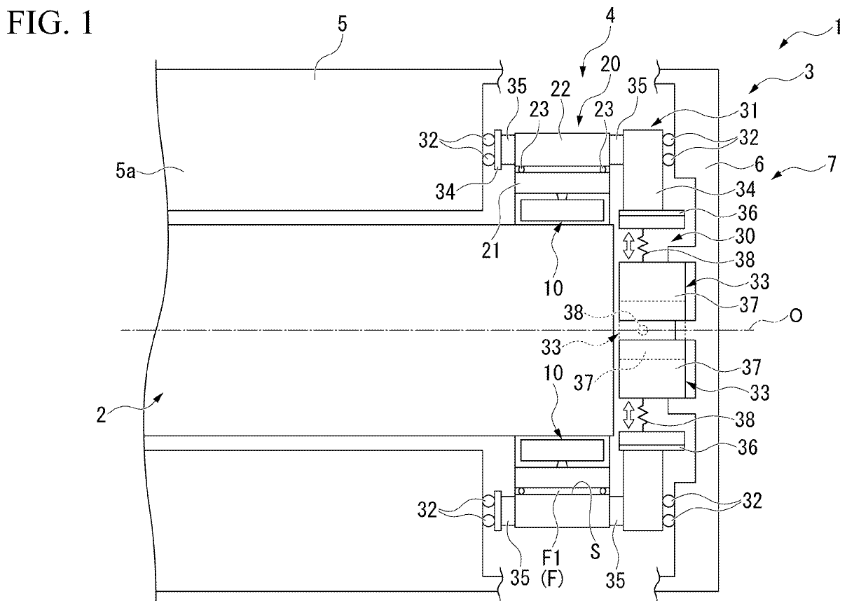

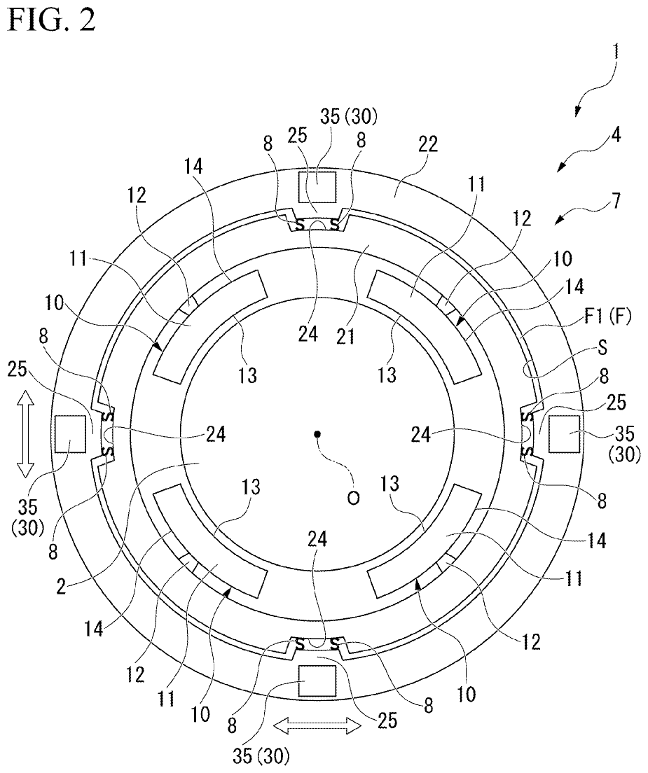

Hereinafter, a squeeze film damper bearing 7, a bearing device 4, and a rotating machine 1 according to a first embodiment of the present disclosure will be described with reference to FIGS. 1 and 2.

As shown in FIG. 1, the rotating machine 1 includes a rotor 2, a casing 3, and the bearing device 4. The rotating machine 1 is, for example, a compressor such as a steam turbine that pumps a fluid.

The rotor 2 extends in one direction along an axis O. Hereinafter, the axis O of the rotor 2 will be simply referred to as an “axis O.” Furthermore, a direction in which an axis O direction extends is referred to as a “direction of the axis O,” a radial direction with respect to the axis O is simply referred to as a “radial direction,” and a circumferential direction around the axis O is simply referred to as a “circumferential direction.” The rotor 2 receives a driving force of a motor (not shown) and rotates around the axis O.

In this embodiment, the axis O of the rotor 2 extends in a horizontal direction. Hereinafter, a vertical up-down direction will be referred to as an “up-down direction,” and in the horizontal direction, a direction perpendicular to the up-down direction and the direction of the axis O will be referred to as a “left-right direction.”

The casing 3 covers the rotor 2 from the outside. While the rotor 2 is a moving structure that rotates around the axis O, the casing 3 is a stationary structure that is stationary relative to the rotor 2. The casing 3 has a peripheral wall portion 5 and an end wall portion 6. The peripheral wall portion 5 is a member that has a tubular shape and extends in the direction of the axis O and covers the entire perimeter of the rotor 2 in the circumferential direction from the outside in the radial direction. The peripheral wall portion 5 has a stepped portion 5a that protrudes inward in the radial direction from an inner peripheral surface thereof. The end wall portion 6 is provided at an end portion of the peripheral wall portion 5 in the direction of the axis O, and covers an internal space of the peripheral wall portion 5 from the outside in the direction of the axis O.

### (Bearing Device)

The bearing device 4 is provided inside the casing 3 together with the rotor 2. The bearing device 4 supports the rotor 2 in the radial direction. The bearing device 4 includes a bearing part 10 and the squeeze film damper bearing 7.

### (Bearing Part)

The bearing part 10 is a member capable of supporting the rotor 2, and is provided on the side of the outer periphery of the rotor 2. In this embodiment, a plurality (for example, four) of bearing parts 10 are provided at equal intervals in the circumferential direction. The bearing part 10 includes a bearing pad 11 and a pivot 12.

The bearing pad 11 extends in the circumferential direction along the outer peripheral surface of the rotor 2 in an arc shape. The bearing pad 11 is formed into a fan shape when seen in the direction of the axis O. The bearing pad 11 has a predetermined width in the direction of the axis O. The bearing pad 11 has a bearing surface 13 facing inward in the radial direction. The bearing surface 13 comes into contact with the outer peripheral surface of the rotor 2 and supports the rotor 2 from the outside in the radial direction. The bearing pad 11 also has a pad back surface 14 facing outward in the radial direction. The pivot 12 is provided outward in the radial direction with respect to the pad back surface 14.

The pivot 12 is provided corresponding to each bearing pad 11. The pivot 12 is provided on the inner peripheral surface of an internal support ring 21 of the squeeze film damper bearing 7 which will be described later, and supports the bearing pad 11 from the outside in the radial direction by being in contact with the pad back surface 14.

### (Squeeze Film Damper Bearing)

The squeeze film damper bearing 7 includes a squeeze film damper 20, an elastic part 8, and a movement support part 30.

### (Squeeze Film Damper)

The squeeze film damper 20 includes an internal support ring 21, an external support ring 22, and a seal part 23.

### (Internal Support Ring)

The internal support ring 21 supports the bearing part 10 inward in the radial direction. The internal support ring 21 is a member that has an annular shape and surrounds the bearing part 10 from the outside in the radial direction. The central axis of the internal support ring 21 is along the axis O of the rotor 2.

Furthermore, a groove portion 24 that is open toward the outside in the radial direction is formed in the outer peripheral surface of the internal support ring 21. A plurality of (four in the illustrated example) groove portions 24 are formed at equal intervals in the radial direction.

### (External Support Ring)

The external support ring 22 is a member that has an annular shape and is provided outside the internal support ring 21 in the radial direction and covers the outer peripheral surface of the internal support ring 21. The external support ring 22 forms a damper clearance S having an annular shape between the internal support ring 21 and the external support ring 22.

The damper clearance S is filled with a viscous fluid F such as oil. The viscous fluid F filled into the damper clearance S forms a fluid film F1 having an annular shape in accordance with a shape of the damper clearance S. A film thickness of the fluid film F1 in the radial direction changes according to a displacement of the internal support ring 21. Specifically, the film thickness of the fluid film F1 decreases in a region in which the internal support ring 21 is displaced outward in the radial direction due to application of a load in the radial direction from the rotating rotor 2, while on the other hand, a film pressure of the fluid film F1 increases in a region in which the internal support ring 21 is displaced inward in the radial direction.

Furthermore, a protruding portion 25 is provided on the inner peripheral surface of the external support ring 22 at a position radially opposite to each of the groove portions 24 of the internal support ring 21. Similar to the groove portions 24, a plurality of (four in this embodiment) protruding portions 25 are formed side by side in the circumferential direction. The protruding portions 25 are provided at positions in which they respectively enter the facing groove portions 24 from the outside in the radial direction.

The seal part 23 is disposed between the internal support ring 21 and the external support ring 22. The seal part 23 prevents the viscous fluid F filled into the damper clearance S from flowing out.

### (Elastic Part)

The elastic part 8 is provided between each of the groove portions 24 of the internal support ring 21 and each of the protruding portions 25 of the external support ring 22, and connects the internal support ring 21 and the external support ring 22 with each other in the radial direction. The elastic part 8 is a member that expands and contracts in the radial direction and is elastically deformable. The elastic part 8 is provided for each of the protruding portions 25 of the external support ring 22 and connects the internal support ring 21 and the external support ring 22 with each other in the radial direction. The elastic part 8 of this embodiment is, for example, a spring formed in an S-shape when seen in the direction of the axis O. Two elastic parts 8 are provided within each of the groove portions 24 to be spaced apart in the circumferential direction.

### (Movement Support Part)

The movement support part 30 supports the external support ring 22 so as to be movable in a cross-sectional view perpendicular to the axis O. The movement support part 30 includes a holding member 31, a first moving connection part 32, and a moving mechanism 33.

### (Holding Member)

The holding member 31 holds the external support ring 22. The holding member 31 is installed beside the external support ring 22 in the direction of the axis O. The holding member 31 has a base portion 34 and an arm portion 35.

The base portion 34 is formed, for example, in an annular shape surrounding the axis O from the outside in the radial direction. A central axis of the base 34 is along the axis O. A pair of base portions 34 are provided on both sides of the external support ring 22 in the direction of the axis O. In the pair of base portions 34, the base portion 34 on the stepped portion 5a side of the casing 3 in the direction of the axis O is connected to the stepped portion 5a via the first moving connection part 32, and the base portion 34 on the end wall portion 6 side of the casing 3 in the direction of the axis O is connected to the end wall portion 6 via the first moving connection part 32.

The arm portion 35 is, for example, a rigid beam that extends linearly from the base portion 34 toward the external support ring 22 in the direction of the axis O. The arm portion 35 connects the base portion 34 to an external ring support portion. A plurality of (four in this embodiment) arm portions 35 are provided at equal intervals in the circumferential direction. Each of the arm portions 35 is fixed to the base portion 34 and the external support ring 22.

A connecting portion 36 is provided at a radially inner end portion of the base portion 34. In this embodiment, in the pair of base portions 34, the connecting portion 36 is provided at the base portion 34 on the end wall portion 6 side in the direction of the axis O. The moving mechanism 33 is connected to the connecting portion 36.

### (First Moving Connection Part)

The first moving connection part 32 connects the base portion 34 to the stepped portion 5a or the end wall portion 6 so as to be movable in the radial direction. The first moving connection part 32 is, for example, a rolling element such as a roller.

### (Moving Mechanism)

The moving mechanism 33 is provided inside the holding member 31 in the radial direction. The moving mechanism 33 allows the holding member 31 to move in the radial direction. In this embodiment, on a virtual plane orthogonal to the axis O, a pair of moving mechanisms 33 that allows the holding member 31 to move in a first direction (the up-down direction in the example of FIG. 1) are disposed on both sides of the axis O in the first direction (both sides thereof in the up-down direction in the example of FIG. 1), and a pair of moving mechanisms 33 that allows the holding member 31 to move in a second direction are disposed on both sides in the second direction (both sides in the left-right (horizontal) direction in the example of FIG. 1). Both the first direction and the second direction are examples of the radial direction. The moving mechanism 33 is, for example, a hydraulic mechanism. The movement support part 30 controls the position of the external support ring 22 in the up-down direction and the left-right (horizontal) direction by coordinating the four moving mechanisms 33. Each of the moving mechanisms 33 has a main body portion 37 and an extendable portion 38. The main body portion 37 is fixed to the casing 3 (the end wall portion 6 in the illustrated example). The extendable portion 38 extends in the radial direction from the main body portion 37 toward the connecting portion 36 of the holding member 31. The moving mechanism 33 causes the holding member 31 to move in the radial direction by extending and contracting the extendable portion 38 in the radial direction. Thus, the position of the external support ring 22 in the radial direction is adjusted.

The moving mechanisms 33 in FIG. 1 are only schematically illustrated. For example, the moving mechanism 33 that allows the holding member 31 to move in the up-down direction may be disposed only on one side in the up-down direction with respect to the axis O, and the moving mechanism 33 that allows the holding member 31 to move in the up-down direction may be disposed only on one side in the left-right direction with respect to the axis O.

### (Effects)

Hereinafter, effects of the squeeze film damper bearing 7 of this embodiment will be described. First, an operation of the squeeze film damper bearing 7 will be described.

For example, in a state in which the fluid film F1 is formed within the damper clearance S, when the rotor 2, the bearing part 10, and the internal support ring 21 vibrate as the rotor 2 rotates, the width of the damper clearance S changes according to the vibration. Due to the change in the width of the damper clearance S, the viscous fluid F forming the fluid film F1 moves in the axial direction or the circumferential direction. Pressure is generated due to a squeezing action caused by viscous resistance of the viscous fluid F according to movement of the viscous fluid F, and a damping effect against vibration can be obtained.

However, when the rotor 2 is displaced in the radial direction or when the load applied to the rotor 2 in the radial direction changes, the internal support ring 21 moves in the radial direction in accordance with the displacement of the rotor 2. Thus, the width of the damper clearance S between the internal support ring 21 and the external support ring 22 becomes narrower, and there is a possibility that the internal support ring 21 and the external support ring 22 may come into contact with each other. As a countermeasure against this problem, a movement support part 30 is provided on the squeeze damper bearing of this embodiment. The movement support part 30 supports the squeeze film damper 20 with the external support ring 22, and allows the external support ring 22 to move relative to the internal support ring 21 in a cross-sectional view perpendicular to the axis O. For example, when a downward static deflection occurs in the rotor 2 due to its own weight, the movement support part 30 moves the center of the external support ring 22 downward. For example, when an upward static load is generated on the rotor 2 during an operation according to operating conditions, the movement support part 30 moves the center of the external support ring 22 upward in accordance with an upward displacement of the rotor 2.

In this manner, in this embodiment, the external support ring 22 can be moved in accordance with the displacement of the rotor 2. Thus, the position of the external support ring 22 can be adjusted so that the center of the external support ring 22 is disposed on the axis O of the rotor 2. Therefore, positioning of the squeeze film damper 20 can be performed in consideration of the initial static deflection and static load of the rotor 2, and positioning of the squeeze film damper 20 can be performed in response to changes in load according to operating conditions. Therefore, since contact between the internal support ring 21 and the external support ring 22 is curbed, there is no need to set the damper clearance S large in consideration of the possibility of contact between the internal support ring 21 and the external support ring 22.

As described above, the fluid film F1 filled into the damper clearance S is made thinner by further narrowing the damper clearance S while the possibility of contact between the internal support ring 21 and the external support ring 22 is reduced. Therefore, the damping performance can be improved, and the stability of the rotating machine 1 is improved.

However, in order to obtain the same effect as this embodiment, for example, it is conceivable to support the internal support ring 21 movably, but the damper clearance S between the internal support ring 21 and the external support ring 22 becomes non-uniform in the circumferential direction. For this reason, when the internal support ring 21 is pushed downward due to vibrations of the rotor 2, for example, a lower damper clearance S narrows and the damping characteristics improve, while an upper damper clearance S widens and the damping characteristics deteriorate.

Furthermore, when a load direction or an amount of load changes according to operating conditions, it is necessary to adjust the position of the squeeze film damper 20 during an operation. However, when the internal support ring 21 is moved, a movement range of the internal support ring 21 is limited by the external support ring 22, and the damper clearance S may not be maintained when the load is large.

In contrast, in this embodiment, as described above, the internal support ring 21 is located inside the external support ring 22 via the damper clearance S, and the external support ring 22 is movably supported by the movement support part 30. Therefore, it is possible to maintain the narrow damper clearance S uniformly in the circumferential direction by adjusting the position of the external support ring 22. Therefore, good damping characteristics can be maintained.

Furthermore, even when the load direction or the amount of load changes during an operation, the position of the external support ring 22 is adjusted in this embodiment, and thus the damper clearance S can be easily maintained.

In this embodiment, the movement support part 30 includes the holding member 31 and the moving mechanism 33. The movement support part 30 is installed beside the external support ring 22 in the direction of the axis O and holds the external support ring 22. The moving mechanism 33 is provided inside the holding member 31 in the radial direction and allows the holding member 31 to move in the radial direction.

Thereby, it is possible to curb an increase in the size of the squeeze film damper bearing 7 in the radial direction.

In this embodiment, the squeeze film damper bearing 7 has the elastic part 8 that connects the internal support ring 21 and the external support ring 22 with each other in the radial direction. The elastic part 8 is elastically deformable in the radial direction.

The elastic part 8 facilitates interlocking between the external support ring 22 and the internal support ring 21 without contact therebetween. Therefore, the external support ring 22 can be positioned while being supported by the movement support part 30 so that the external support ring 22 does not come into contact with the internal support ring 21.

From the viewpoint of preventing contact between the internal support ring 21 and the external support ring 22, preferably, a plurality of elastic parts 8 are provided in the circumferential direction.

### Second Embodiment

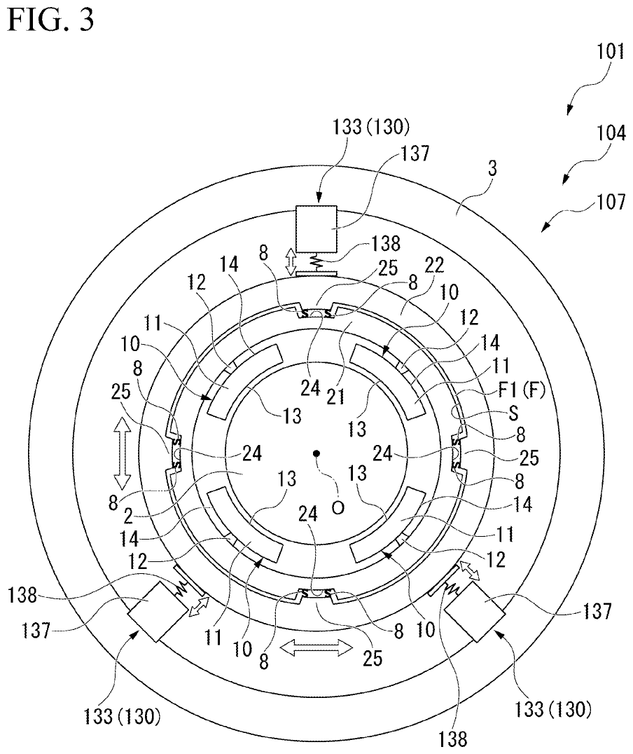

Hereinafter, a squeeze film damper bearing 107, a bearing device 104, and a rotating machine 101 according to a second embodiment of the present disclosure will be described with reference to FIG. 3. In the second embodiment, the same components as those in the above embodiment are given the same names and reference numerals, and a description thereof will be omitted as appropriate.

In this embodiment, as shown in FIG. 3, the movement support part 130 includes a moving mechanism 133. The moving mechanism 133 is disposed outside the external support ring 22 in the radial direction. The moving mechanism 133 supports the external support ring 22 so as to be movable in the radial direction. The moving mechanism 133 of this embodiment is a hydraulic mechanism similarly to the first embodiment.

A plurality of (three in this embodiment) moving mechanisms 133 are provided at intervals in the circumferential direction. In this embodiment, one moving mechanism 133 is disposed above the external support ring 22 and two moving mechanisms 133 are disposed below the external support ring 22. The one moving mechanism 133 disposed above is located directly above the axis O. The two moving mechanisms 133 disposed below are disposed at symmetrical positions so as to sandwich the external support ring 22 from both sides in the horizontal direction while supporting the external support ring 22 from below. The external support ring 22 is supported at three points by the three moving mechanisms 133. The movement support part 130 controls the position of the external support ring 22 in the up-down direction and the left-right (horizontal) direction by coordinating the three moving mechanisms 133.

The moving mechanism 133 has a main body portion 137 and an extendable portion 138. The main body portion 137 is disposed to be spaced apart from the external support ring 22 in the radial direction. The main body portion 137 is fixed to a casing 3 (the peripheral wall portion 5 in the illustrated example). The extendable portion 138 extends inward from the main body portion 137 in the radial direction. The extensible portion 138 connects the main body portion 137 to the outer peripheral surface of the external support ring 22. In the extensible portion 138 of this embodiment, rigidity in the radial direction is set to be larger than rigidity in the circumferential direction. Examples of the extendable portion 138 include a cylindrical rod, a cross rod, a stinger, and the like. Furthermore, in this embodiment, the moving mechanism 133 is fixed to the casing 3.

### (Effect)

Hereinafter, the effects of the squeeze film damper bearing 107 of this embodiment will be described.

In this embodiment, the movement support part 130 includes a moving mechanism 133 that is disposed outside the external support ring 22 in the radial direction and holds the external support ring 22 to be movable in the radial direction.

Thus, it is possible to curb an increase in the size of the squeeze film damper bearing 107 in the direction of the axis O.

Furthermore, the moving mechanism 133 can directly receive a radial load transmitted from the external support ring 22 from the outside in the radial direction. Thus, stability is improved, and damping performance can be further improved.

Further, in this embodiment, the external support ring 22 is supported at three points by the three moving mechanisms 133.

Thus, each of the three moving mechanisms 133 can adjust a degree of expansion and contraction of the extendable portion 138 and can adjust the external support ring 22 to an optimal position. Furthermore, the internal support ring 21 is located inside the external support ring 22 via a damper clearance S and thus can maintain the narrow damper clearance S more uniformly in the circumferential direction by adjusting the external support ring 22 to the optimal position. Therefore, damping characteristics can be maintained even better.

Furthermore, even when a load direction or an amount of load changes during an operation, in this embodiment, since the position of the external support ring 22 is adjusted, the damper clearance S can be easily maintained, as in the first embodiment.

### Modified Example of Second Embodiment

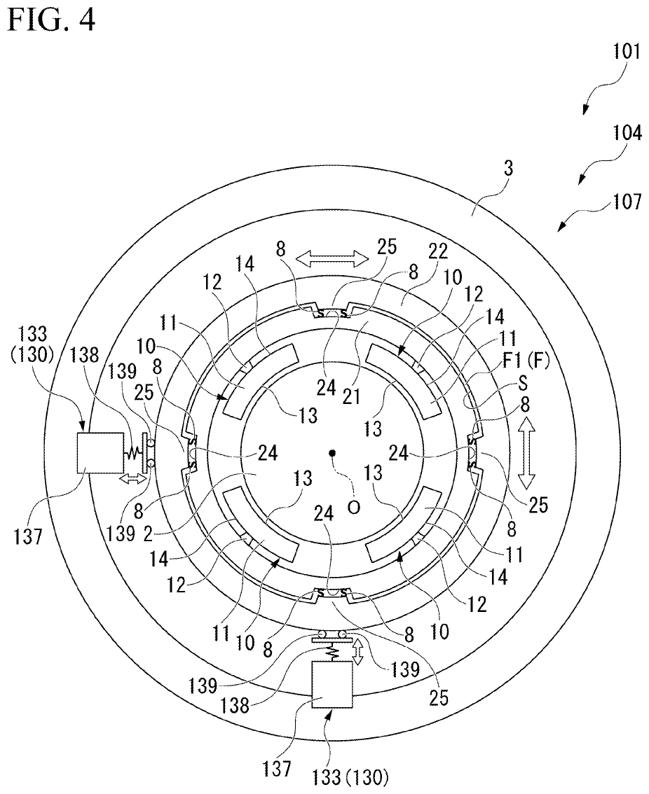

Next, a modified example of the second embodiment will be described with reference to FIG. 4.

### (Second Moving Connection Part)

As shown in FIG. 4, in this modified example, the movement support part 130 further includes a second moving connection part 139 (a moving connection part) that connects the moving mechanism 133 to the external support ring 22 in a direction perpendicular to a movement direction (in this embodiment, a direction of expansion and contraction by the extendable portion 138 in the radial direction) by the moving mechanism 133. The second moving connection part 139 is, for example, a rolling element such as a roller.

Thus, the movement of the external support ring 22 in the direction orthogonal to the movement direction by the moving mechanism 133 is no longer restricted. Therefore, the position of the external support ring 22 can be adjusted with higher precision.

For example, in the example of FIG. 4, one moving mechanism 133 is disposed below the squeeze film damper 20 and one moving mechanism 133 is disposed on one side in the horizontal direction (the left side in the drawing). The lower moving mechanism 133 adjusts the position of the external support ring 22 in the up-down direction by expanding and contracting the extendable portion 138, and the moving mechanism 133 on one side in the horizontal direction (the left side in the drawing) adjusts the position of the external support ring 22 in the left-right (horizontal) direction by expanding and contracting the extendable portion 138.

In this modified example, the number of moving mechanisms 133 can be minimized. Therefore, the squeeze film damper bearing 107 can be manufactured with an even smaller number of parts. As described above, in the example of FIG. 4, one moving mechanism 133 is disposed below the squeeze film damper 20 and one moving mechanism 133 is disposed on one side in the horizontal direction. Thus, manufacturing costs can be reduced, and miniaturization can be achieved.

### Third Embodiment

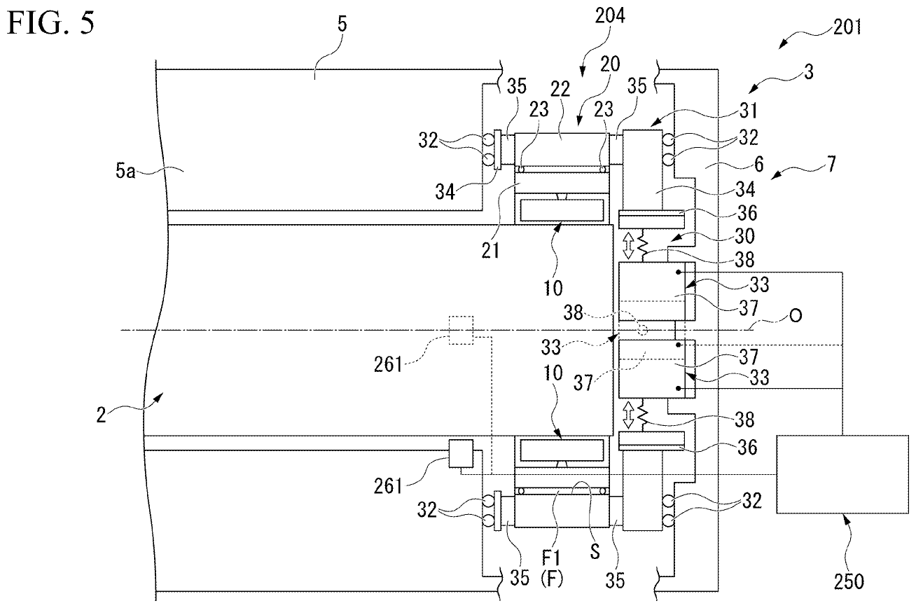

Hereinafter, a squeeze film damper bearing 7, a bearing device 204, and a rotating machine 201 according to a third embodiment of the present disclosure will be described with reference to FIGS. 5 to 10. In the third embodiment, the same components as those in the above embodiment will be given the same names and reference numerals, and the description thereof will be omitted as appropriate.

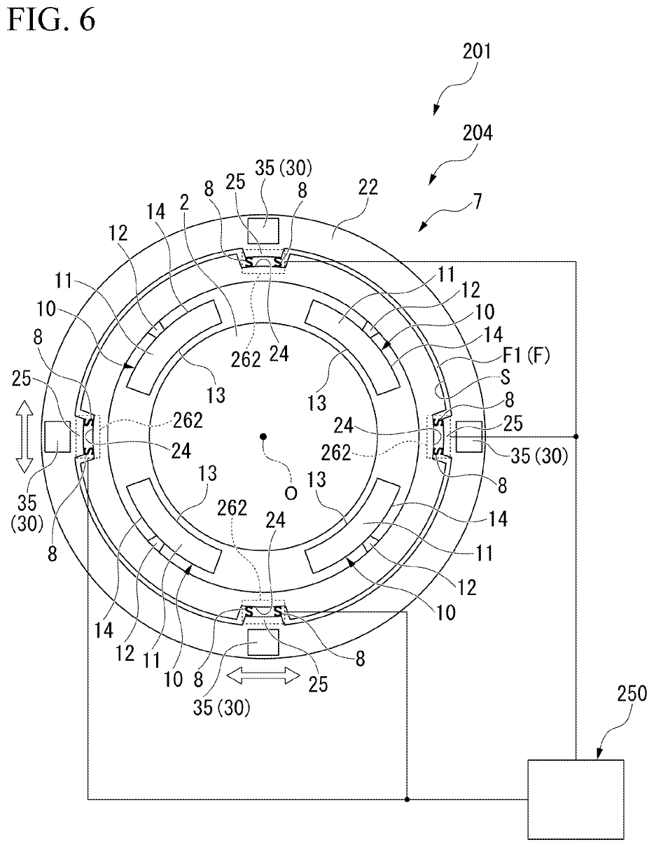

In this embodiment, as shown in FIGS. 5 and 6, the bearing device 4, 204 further includes a first sensor 261, a second sensor 262, and a control part 250.

### (First Sensor)

The first sensor 261 detects the position of the rotor 2 in a plane intersecting the axis O. In this embodiment, the first sensor 261 is mounted on the peripheral wall portion 5 of the casing 3. The first sensor 261 is disposed at a position spaced apart from the outer peripheral surface of the rotor 2 in the radial direction. For example, one first sensor 261 is disposed below the rotor 2 in the up-down direction, and another first sensor 261 is disposed on one side of the rotor 2 in the left-right (horizontal) direction. The first sensor 261 located below the rotor 2 in the up-down direction detects the position of the rotor 2 in the up-down direction in a plane perpendicular to the axis O, and the first sensor 261 on one side in the left-right (horizontal) direction detects the position of the rotor 2 in the horizontal direction.

The first sensor 261 may detect the position of the rotor 2 in a plane slightly inclined from the plane perpendicular to the axis O.

### (Second Sensor)

The second sensor 262 detects the size of the damper clearance S formed between the internal support ring 21 and the external support ring 22. The second sensor 262 is disposed between the internal support ring 21 and the external support ring 22. That is, the second sensor 262 is disposed at a position adjacent to the damper clearance S in the circumferential direction.

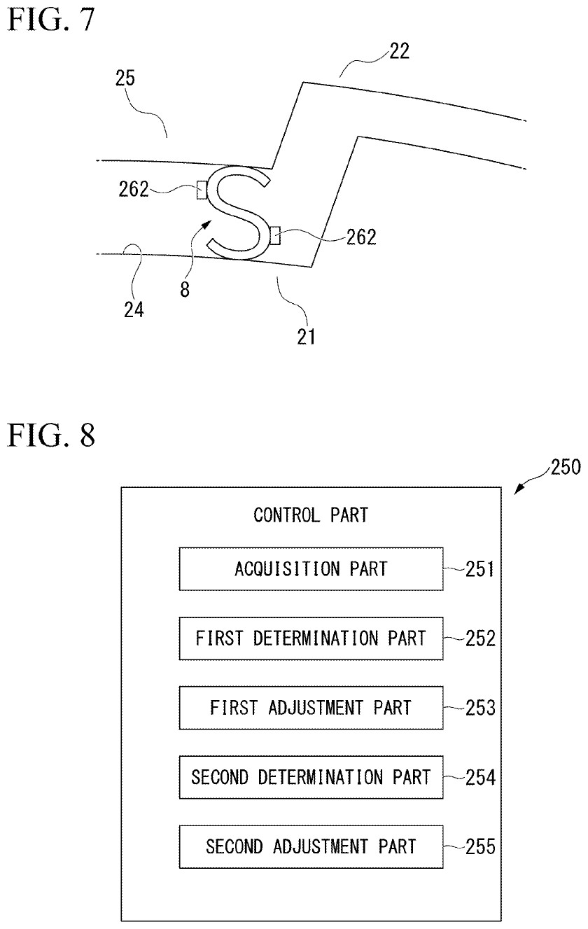

In this embodiment, the second sensor 262 is disposed together with the elastic part 8 in a groove portion 24 between internal supports. Further, the second sensor 262 is, for example, a strain gauge. For example, as shown in FIG. 7, one second sensor 262 is provided at each of curved portions of an elastic part 8 having an S shape.

### (Control Part)

The control part 250 is electrically connected to the first sensor 261 and the second sensor 262, and detection values of the first sensor 261 and the second sensor 262 are transmitted thereto. Further, the control part 250 is connected to the moving mechanism 33 of the movement support part 30. The position of the external support ring 22 is adjusted by operating the movement support part 30 on the basis of the detection value of the first sensor 261 and the detection value of the second sensor 262.

As shown in FIG. 8, the control part 250 includes an acquisition part 251, a first determination part 252, a first adjustment part 253, a second determination part 254, and a second adjustment part 255.

The acquisition part 251 acquires the detection value of the first sensor 261 (position information of the rotor 2) and the detection value of the second sensor 262 (the size of the damper clearance S).

The first determination part 252 determines whether or not the position of the external support ring 22 needs to be adjusted based on the detection value of the first sensor 261.

The first adjustment part 253 adjusts the position of the external support ring 22 when the first determination part 252 determines that the position of the external support ring 22 needs to be adjusted.

The second determination part 254 determines whether or not the position of the external support ring 22 needs to be adjusted based on the detection value of the second sensor 262.

The second adjustment part 255 adjusts the position of the external support ring 22 when the second determination part 254 determines that the position of the external support ring 22 needs to be adjusted.

### (Procedures of Adjustment Method)

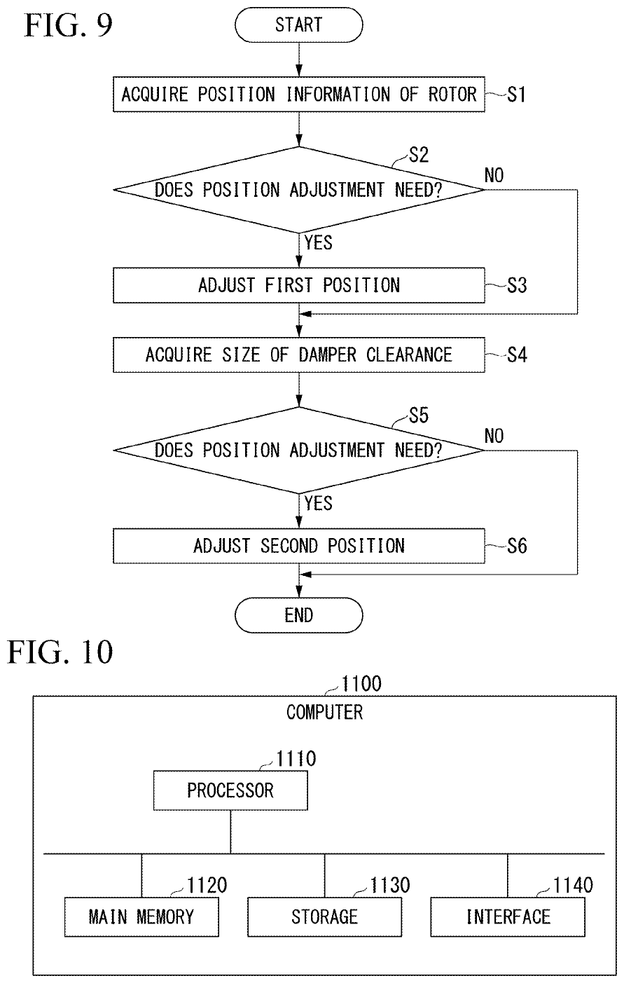

A method for adjusting the external support ring 22 according to this embodiment will be described with reference to a flowchart in FIG. 9.

As shown in FIG. 9, the method for adjusting the external support ring 22 includes a first acquisition step (Step S1), a first determination step (Step S2), a first adjustment step (Step S3), a second acquisition step (Step S4), a second determination step (Step S5), and a second adjustment step (Step S6). First, the acquisition part 251 acquires the detection value (the position information of the rotor 2) of the first sensor 261 (Step S1).

After Step S1, the first determination part 252 determines whether or not the position of the external support ring 22 needs to be adjusted based on the detection value of the first sensor 261 (Step S2).

When the position of the external support ring 22 needs to be adjusted (Step S2: YES), the first adjustment part 253 adjusts the position of the external support ring 22 (Step S3). After Step S3, the acquisition part 251 acquires the detection value (the size of damper clearance S) of the second sensor 262 (Step S4). On the other hand, when the position of the external support ring 22 does not need to be adjusted (Step S2: NO), Step S4 is performed without passing through Step S3.

After Step S4, the second determination part 254 determines whether or not the position of the external support ring 22 needs to be adjusted based on the detection value of the second sensor 262 (Step S5).

When the position of the external support ring 22 needs to be adjusted (Step S5: YES), the second adjustment part 255 adjusts the position of the external support ring 22 (Step S6). After Step S6, the position adjustment of the external support ring 22 is completed. Step S6 is a step of finely adjusting the damper clearance S. On the other hand, when the adjustment of the external support ring 22 does not need to be adjusted (Step S5: NO), the position adjustment of the external support ring 22 is completed without going through Step S6.

After the above steps, the position adjustment of the external support ring 22 is completed.

### (Hardware Configuration)

The control part 250 described above is mounted in a computer 1100 shown in FIG. 10. FIG. 10 is a schematic block diagram showing a configuration of the computer 1100 according to each embodiment. The computer 1100 includes a processor 1110, a main memory 1120, a storage 1130, and an interface 1140.

An operation of each of the above-described functional parts of the control part 250 is stored in the storage 1130 in the form of a program. The processor 1110 reads the program from storage 1130, develops it to the main memory 1120, and performs the above processing according to the program. Furthermore, the processor 1110 reserves a storage region in the main memory 1120 according to the program.

The program may be for implementing part of the functions that the computer 1100 performs. For example, the program may cause the functions to be performed in combination with other programs already stored in the storage 1130 or in combination with other programs installed in other devices. Further, the computer 1100 may include a custom large scale integrated circuit (LSI) such as a programmable logic device (PLD) in addition to or in place of the above configuration. Examples of the PLD include programmable array logic (PAL), generic array logic (GAL), complex programmable logic device (CPLD), and field programmable gate array (FPGA). In this case, part or all of the functions implemented by processor 1110 may be implemented by the integrated circuit.

Examples of the storage 1130 include a magnetic disk, a magneto-optical disk, a semiconductor memory, and the like. The storage 1130 may be an internal medium connected directly to a bus of the computer 1100, or may be an external medium connected to the computer 1100 via the interface 1140 or a communication line. Further, when the program is transmitted to the computer 1100 via a communication line, the computer 1100 that received the program may develop the program in the main memory 1120 and may perform the above processing. The storage 1130 may be a non-transitory tangible storage medium.

Further, the program may be for implementing part of the above-described functions. Furthermore, the program may be a so-called difference file (a difference program) that implements the above-described functions in combination with other programs already stored in the storage 1130.

### (Effect)

Hereinafter, effects of the squeeze film damper bearing 7 of this embodiment will be described.

In this embodiment, the bearing device 204 further includes the first sensor 261 that detects the position of the rotor 2, and the control part 250 that operates the movement support part 30 on the basis of the detection value of the first sensor 261 to adjust the position of the external support ring 22.

Thus, the bearing device 204 can finely adjust the width of the damper clearance S without stopping the operation of the rotating machine 201. Therefore, contact between the internal support ring 21 and the external support ring 22 can be efficiently curbed.

In this embodiment, the bearing device 204 further includes the second sensor 262 that detects the size of the damper clearance S, and the control part 250 that operates the movement support part 30 to adjust the position of the external support ring 22 on the basis of the detection value of the second sensor 262.

Thus, the bearing device 204 can finely adjust the width of the damper clearance S without stopping the operation of the rotating machine 201. Therefore, the fluid film F1 filled in the damper clearance S can be adjusted even more efficiently with high precision.

In this embodiment, after the position of the external support ring 22 is roughly adjusted on the basis of the detection value of the first sensor 261, the width of the damper clearance S is finely adjusted on the basis of the detection value of the second sensor 262, and the position of the external support ring 22 is adjusted in two stages. Thus, the position of the external support ring 22 can be adjusted even more efficiently with high precision.

In the third embodiment, the case in which the bearing device 204 includes both the first sensor 261 and the second sensor 262 has been described, but the present disclosure is not limited thereto. The bearing device 204 may include only one of the first sensor 261 and the second sensor 262, and may control the movement support part 30 to perform the position adjustment of the external support ring 22 on the basis of the detection value of the one sensor.

### Other Embodiments

Although the embodiment of the present disclosure has been described above in detail with reference to the drawings, the specific configuration is not limited to this embodiment, and includes design changes or the like within the scope of the gist of the present disclosure.

In the embodiments described above, compressors, steam turbines, and the like are cited as examples of the rotating machines 1, 101, and 201 in which the above-described squeeze damper bearings are mounted, but the present disclosure is not limited thereto.

Further, in the above embodiment, the case in which four bearing parts 10 are provided and arranged in a row in the circumferential direction has been described, but the present disclosure is not limited thereto. The number of bearing parts 10 can be changed as appropriate.

Further, in the above embodiment, the case in which the elastic part 8 is an S-shaped spring formed in an S-shape when seen in the direction of the axis O has been described, but the present disclosure is not limited thereto. For example, the elastic part 8 may be a bellows, a C-shaped spring, a block made of an elastic material, or the like.

### Additional Notes

The squeeze film damper bearings 7 and 107, bearing devices 4, 104, and 204, and rotating machines 1, 101, and 201 described in each of the embodiments are understood as follows, for example.

(1) A squeeze film damper bearing 7, 107 according to a first aspect includes a squeeze film damper 20 including an internal support ring 21 configured to support a bearing part 10, which is allowed to support the rotor 2 extending in an axis O, via an inner peripheral surface of the internal support ring 21 in a radial direction of the axis O, and an external support ring 22 installed outside the internal support ring 21 in the radial direction so that an annular damper clearance S which is filled with a viscous fluid F is formed between the external support ring 22 and the internal support ring 21, and a movement support part 30, 130 configured to support the squeeze film damper 20 via the external support ring 22 to allow the external support ring 22 to move relative to the internal support ring 21 in a cross-sectional view perpendicular to the axis O.

Thus, the external support ring 22 can be moved in accordance with the displacement of the rotor 2. Therefore, contact between the internal support ring 21 and the external support ring 22 is curbed.

(2) A squeeze film damper bearing 7 of a second aspect is the squeeze film damper bearing 7 of (1), and the movement support part 30 may include a holding member 31 installed beside the external support ring 22 in a direction of the axis O and configured to hold the external support ring 22, and a moving mechanism 33 installed inside the holding member 31 in the radial direction and configured to allow the holding member 31 to move in the radial direction.

Thus, it is possible to curb an increase in the size of the squeeze film damper bearing 7 in the radial direction.

(3) A squeeze film damper bearing 107 of a third aspect is the squeeze film damper bearing 107 of (1), and the movement support part 130 may include a moving mechanism 133 installed outside the external support ring 22 in the radial direction, and the moving mechanism 133 may support the external support ring 22 to move in the radial direction.

Thus, it is possible to curb an increase of the size of the squeeze film damper bearing 107 in the direction of the axis O.

(4) A squeeze film damper bearing 107 of a fourth aspect is the squeeze film damper bearing 107 of (3), and the movement support part 130 may include a moving connection part that connects the moving mechanism 133 to the external support ring 22 so that the moving mechanism 133 is allowed to move in a direction orthogonal to a movement direction of the external support ring 22 by the moving mechanism 133.

An example of the moving connection part is the second moving connection part 139 of the embodiment described above.

Thus, the movement of the external support ring 22 in the direction orthogonal to the movement direction by the moving mechanism 133 is no longer restricted. Therefore, the position of the external support ring 22 can be adjusted with higher precision.

(5) A bearing device 4, 104, 204 of a fifth aspect includes the squeeze film damper bearing 7, 107 of any one of (1) to (4) and the bearing part 10.

(6) A bearing device 204 of a sixth aspect is the bearing device 204 of (5), and may further include a first sensor 261 configured to detect a position of the rotor 2, and a control part 250 configured to operate the movement support part 30 and to adjust a position of the external support ring 22 on the basis of a detection value of the first sensor 261.

Thus, the bearing device 204 can move the external support ring 22 according to a displacement of the rotor 2 without stopping an operation of the rotating machine 201.

(7) A bearing device 204 of a seventh aspect is the bearing device 204 of (5) or (6), and may further include a second sensor 262 configured to detect a size of the damper clearance S, and a control part 250 configured to operate the movement support part 30 and to adjust the position of the external support ring 22 on the basis of a detection value of the second sensor 262.

Thus, the bearing device 204 can finely adjust the width of the damper clearance S without stopping the operation of the rotating machine 201.

(8) A rotating machine 1, 101, 201 of an eighth aspect includes the bearing device 4, 104, 204 of any one of (5) to (7) and the rotor 2.

### EXPLANATION OF REFERENCES

1 Rotating machine
2 Rotor
3 Casing
4 Bearing device
5 Peripheral wall portion
5a Stepped portion
6 End wall portion
7 Squeeze film damper bearing
8 Elastic part
10 Bearing part
11 Bearing pad
12 Pivot
13 Bearing surface
14 Pad back surface
20 Squeeze film damper
21 Internal support ring
22 External support ring
23 Seal part
24 Groove portion
25 Protruding portion
30 Movement support part
31 Holding member
32 First moving connection part
33 Moving mechanism
34 Base portion
35 Arm portion
36 Connecting portion
37 Main body portion
38 Extendable portion
101 Rotating machine
104 Bearing device
107 Squeeze film damper bearing
130 Movement support part
133 Moving mechanism
137 Main body portion
138 Extendable portion
139 Second moving connection part (moving connection part)
201 Rotating machine
204 Bearing device
250 Control part
251 Acquisition part
252 First determination part
253 First adjustment part
254 Second determination part
255 Second adjustment part
261 First sensor
262 Second sensor
1100 Computer
1110 Processor
1120 Main memory
1130 Storage
1140) Interface
F Viscous fluid
F1 Fluid film
O Axis
S Damper clearance

What is claimed is:

1. A squeeze film damper bearing comprising:
a squeeze film damper including an internal support ring configured to support a bearing part, which is allowed to support the rotor extending in an axis, via an inner peripheral surface of the internal support ring in a radial direction of the axis, and an external support ring installed outside the internal support ring in the radial direction so that an annular damper clearance which is filled with a viscous fluid is formed between the external support ring and the internal support ring; and
a movement support part configured to support the squeeze film damper via the external support ring and to allow the external support ring to move relative to the internal support ring in a cross-sectional view perpendicular to the axis.

2. The squeeze film damper bearing according to claim 1, wherein the movement support part includes a holding member installed beside the external support ring in a direction of the axis and configured to hold the external support ring, and a moving mechanism installed inside the holding member in the radial direction and configured to allow the holding member to move in the radial direction.

3. The squeeze film damper bearing according to claim 1, wherein the movement support part includes a moving mechanism installed outside the external support ring in the radial direction, and
the moving mechanism supports the external support ring to move in the radial direction.

4. The squeeze film damper bearing according to claim 3, wherein the movement support part includes a moving connection part configured to connect the moving mechanism to the external support ring so that the moving mechanism is allowed to move in a direction orthogonal to a movement direction of the external support ring by the moving mechanism.

5. A bearing device comprising:
the squeeze film damper bearing according to claim 1; and
the bearing part.

6. The bearing device according to claim 5, further comprising:
a first sensor configured to detect a position of the rotor; and
a control part configured to operate the movement support part and to adjust a position of the external support ring on the basis of a detection value of the first sensor.

7. The bearing device according to claim 5, further comprising:
a second sensor configured to detect a size of the damper clearance; and
a control part configured to operate the movement support part and to adjust the position of the external support ring on the basis of a detection value of the second sensor.

8. A rotating machine comprising:
the bearing device according to claim 5; and
the rotor.
